(19) United States
(12) Patent Application Publication
(10) Pub. No.: US 2025/0061588 A1
(43) Pub. Date: Feb. 20, 2025

(54) INFORMATION PROCESSING DEVICE, INFORMATION PROCESSING METHOD AND PROGRAM RECORDING MEDIUM

(71) Applicant: SEIKO EPSON CORPORATION, Tokyo (JP)

(72) Inventors: Kazumi YAMADA, AZUMINO-SHI (JP); Kazuhiko TSUCHIMOTO, MATSUMOTO-SHI (JP); Shin NISHIMURA, Ontario (CA)

(73) Assignee: SEIKO EPSON CORPORATION, Tokyo (JP)

(21) Appl. No.: 18/801,870

(22) Filed: Aug. 13, 2024

(30) Foreign Application Priority Data
Aug. 14, 2023 (JP) 2023-132107

(51) Int. Cl. G06T 7/246; G06V 10/74

(52) U.S. Cl. CPC G06T 7/246; G06V 10/761; G06T 2207/20044; G06T 2207/30196

(57) ABSTRACT

An information processing device includes: an acquiring unit configured to acquire a first moving image and a second moving image; an extracting unit configured to extract a first motion from the first moving image and extract a second motion from the second moving image; and an evaluating unit configured to determine a plurality of frames of the second moving image, the frames being frames in which a similarity of the second motion of the second moving image relative to the first motion of the first moving image is equal to or more than a predetermined value.

The present application is based on, and claims priority from JP Application Serial Number 2023-132107, filed Aug. 14, 2023, the disclosure of which is hereby incorporated by reference herein in its entirety.

### BACKGROUND

### 1. Technical Field

The present disclosure relates to an information processing device, an information processing method, and a program recording medium.

### 2. Related Art

Processing is performed to a moving image in which a motion performed by a target person serving as a subject is imaged.

JP-A-2015-61237 describes an image superimposing device. In the image superimposing device, one frame in which a target person takes a specific posture serving as a reference is extracted from a moving image in which a golf swing motion performed by the target person is imaged, and is used as a frame having a corresponding swing point. Then, the extracted one frame is synchronized with one frame having a corresponding swing point in a reference moving image (see JP-A-2015-61237).

However, in a case of an existing technique as described above, for example, when a target moving image and the reference moving image are synchronized with each other, these one frames corresponding to the swing point and extracted from individual moving images are used as the reference to perform alignment. Thus, in some cases, an error of synchronization may become large.

For example, when one frame corresponding to the swing point and extracted from the target moving image is not appropriate due to error or the like, a difference from the one frame corresponding to the swing point and extracted from the reference moving image increases, and hence, there is a case where the evaluation on the swing motion results in an unintended result.

### SUMMARY

In order to solve the problem described above, one aspect provides an information processing device including an acquiring unit configured to acquire a first moving image and a second moving image, an extracting unit configured to extract a first motion from the first moving image and extract a second motion from the second moving image, and an evaluating unit configured to determine a plurality of frames of the second moving image, the frames being frames in which a similarity of the second motion of the second moving image relative to the first motion of the first moving image is equal to or more than a predetermined value.

In order to solve the problem described above, one aspect provides an information processing method including acquiring, by an acquiring unit, a first moving image and a second moving image, extracting, by an extracting unit, a first motion from the first moving image, extracting, by the extracting unit, a second motion from the second moving image, and determining, by an evaluating unit, a plurality of frames of the second moving image, the frames being frames in which a similarity of the second motion of the second moving image relative to the first motion of the first moving image is equal to or more than a predetermined value.

In order to solve the problem described above, one aspect provides a non-transitory computer-readable recording medium that records a program, the program causing a computer to perform acquiring a first moving image and a second moving image, extracting a first motion from the first moving image, extracting a second motion from the second moving image, and determining a plurality of frames of the second moving image, the frames being frames in which a similarity of the second motion of the second moving image relative to the first motion of the first moving image is equal to or more than a predetermined value.

### BRIEF DESCRIPTION OF THE DRAWINGS

FIG. 1 is a diagram illustrating an example of a schematic configuration of an information processing device according to an embodiment.

FIG. 2 is a diagram illustrating one example of two moving images according to the embodiment.

FIG. 3 is a diagram illustrating one example of a process of performing evaluation on the basis of joint information in an information processing device according to the embodiment.

FIG. 4A is a diagram illustrating one example of joint-of-interest information according to the embodiment.

FIG. 4B is a diagram illustrating another example of the joint-of-interest information according to the embodiment.

FIG. 4C is a diagram illustrating an example of two pieces of information about the same joint-of-interest information according to the embodiment.

FIG. 4D is a diagram illustrating one example of a result obtained by shifting relative timing of two pieces of information about the same joint-of-interest information according to the embodiment.

FIG. 4E is a diagram illustrating another example of a result obtained by shifting relative timing of two pieces of information about the same joint-of-interest information according to the embodiment.

FIG. 4F is a diagram illustrating another example of a result obtained by shifting relative timing of two pieces of information about the same joint-of-interest information according to the embodiment.

FIG. 5A is a diagram illustrating a first table that holds information about a correlation coefficient for each joint information according to the embodiment.

FIG. 5B is a diagram illustrating a graph showing information about a correlation coefficient for each joint information according to the embodiment.

FIG. 5C is a diagram illustrating a second table that holds one example of a relationship between the correlation coefficient and the degree of misalignment according to the embodiment.

FIG. 6A is a diagram illustrating one example of a display mode of a target person and joints according to the embodiment.

FIG. 6B is a diagram illustrating one example of a display mode of the target person and joints according to the embodiment.

FIG. 7A is a diagram illustrating one example of a display mode of bones and joints of a target person according to the embodiment.

FIG. 7B is a diagram illustrating one example of a display mode of bones and joints of the target person according to the embodiment.

FIG. 8 is a diagram illustrating one example of a display mode of a variation in joints according to the embodiment.

FIG. 9A is a diagram illustrating one example of information about two moving images according to the embodiment.

FIG. 9B is a diagram illustrating one example of two pieces of information about a joint of the right shoulder according to the embodiment.

FIG. 9C is a diagram illustrating one example of a result obtained by shifting relative timing of two pieces of information about the joint of the right shoulder according to the embodiment.

FIG. 9D is a diagram illustrating one example of two pieces of information about a joint of the right knee according to the embodiment.

FIG. 9E is a diagram illustrating one example of a result obtained by shifting relative timing of two pieces of information about the joint of the right knee according to the embodiment.

FIG. 10A is a diagram illustrating one example of two pieces of information about the joint of the right knee according to the embodiment.

FIG. 10B is a diagram illustrating one example of a result obtained by shifting relative timing of two pieces of information about the joint of the right knee according to the embodiment.

FIG. 10C is a diagram illustrating one example of an address posture of the target person according to the embodiment.

FIG. 10D is a diagram illustrating one example of a top position posture of the target person according to the embodiment.

FIG. 11A is a diagram illustrating one example of information about the joint of the right knee according to the embodiment.

FIG. 11B is a diagram illustrating another example of information about the joint of the right knee according to the embodiment.

FIG. 11C is a diagram illustrating an example of two pieces of information about the joint of the right knee according to the embodiment.

FIG. 11D is a diagram illustrating one example of a result obtained by shifting relative timing of two pieces of information about the joint of the right knee according to the embodiment.

FIG. 11E is a diagram illustrating one example of a first form of the target person according to the embodiment.

FIG. 11F is a diagram illustrating one example of a second form of the target person according to the embodiment.

FIG. 11G is a diagram illustrating one example of a third form of the target person according to the embodiment.

FIG. 11H is a diagram illustrating one example of a fourth form of the target person according to the embodiment.

FIG. 11I is a diagram illustrating one example of a fifth form of the target person according to the embodiment.

FIG. 11J is a diagram illustrating one example of a sixth form of the target person according to the embodiment.

### DESCRIPTION OF EMBODIMENTS

Below, embodiment will be described with reference to the drawings.

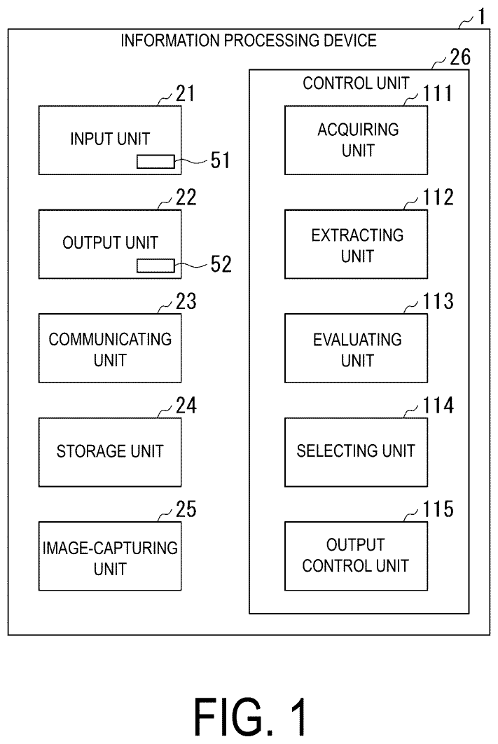

FIG. 1 is a diagram illustrating an example of a schematic configuration of an information processing device 1 according to the embodiment.

In the present embodiment, the information processing device 1 is configured by using a computer.

The information processing device 1 is a smartphone as one example. However, as another example, the information processing device 1 may be a tablet-type terminal, a laptop-type personal computer, or other forms of computer.

The information processing device 1 includes an input unit 21, an output unit 22, a communicating unit 23, a storage unit 24, an image-capturing unit 25, and a control unit 26.

The input unit 21 includes an operation unit 51.

The output unit 22 includes a display unit 52.

The control unit 26 includes an acquiring unit 111, an extracting unit 112, an evaluating unit 113, a selecting unit 114, and an output control unit 115.

The input unit 21 performs a process of inputting information.

For example, the input unit 21 performs a process of inputting information in response to an operation made by a user, or a process of inputting information from another device. This another device may be a mobile-type recording device, for example.

In the present embodiment, the operation unit 51 receives details of an operation made by a user, and performs a process of inputting information in response to the operation by the user. The operation unit 51 may be, for example, a keyboard and a mouse.

The output unit 22 performs a process of outputting information.

For example, the output unit 22 performs a process of outputting information to a user, or a process of outputting information to another device. This another device may be a mobile-type recording device, for example.

In the present embodiment, the display unit 52 includes a screen, and displays, on this screen, information to be displayed.

Note that, as for the mode of outputting information, it may be possible to employ a mode of outputting a sound such as voice in conjunction with display output or independently of display output, for example.

The communicating unit 23 communicates with other devices.

Note that, in the present embodiment, the communicating unit 23 is illustrated separately from the input unit 21 and the output unit 22. However, for example, the function of the communicating unit 23 may be included in the functions of the input unit 21 and the output unit 22.

The storage unit 24 holds information.

In the present embodiment, the storage unit 24 may hold any given information. For example, the storage unit 24 may hold a program that defines processes, a parameter used in the process, information before process, information that is in the middle of the process, or information after process, or the like.

These pieces of information may be information in any given format, and in the present embodiment, include a moving image.

Note that the moving image may be referred to as a motion image or the like.

The image-capturing unit 25 has a function of capturing an image. In the present embodiment, this image is a moving image.

For example, the image-capturing unit 25 is configured by using a camera having a function of capturing a moving image.

The control unit 26 performs various types of processing and also performs control.

The control unit 26 includes a processor such as a central processing unit (CPU), and causes this processor to execute a predetermined program to perform various types of processing and controlling.

This program may be stored in the storage unit 24, for example.

The acquiring unit 111 acquires information. This information includes a moving image, for example.

In the present embodiment, the acquiring unit 111 may acquire one or more of a moving image captured by the image-capturing unit 25, information inputted by the input unit 21, information received by the communicating unit 23, and information held by the storage unit 24.

The extracting unit 112 extracts predetermined information from the moving image.

The evaluating unit 113 performs predetermined evaluation with respect to two moving images. In the present embodiment, the evaluating unit 113 performs predetermined evaluation on the basis of the information extracted by the extracting unit 112.

Note that the evaluation may be referred to as determination, for example.

Here, this evaluation includes various types of evaluation. For example, this evaluation may be one or more of: evaluation performed to determine the number of deviations of frames between two moving images in order to bring the two moving images into synchronization with each other; and evaluation of, after two moving images are brought into synchronization with each other, acquiring information about a difference in terms of predetermined information seen in these two moving images; and the like.

The present embodiment employs a moving image in which a motion of a human is seen. From this moving image, it is possible to determine the position of a joint of the human, or the like.

The selecting unit 114 selects a typical joint from among a plurality of joints as a representative joint. In the present embodiment, the joints are human joints.

Here, the selecting unit 114 may select the representative joint on the basis of details of operation of a user that is received by the operation unit 51, or may automatically select the representative joint on the basis of a predetermined rule, for example.

Note that, as another example, the selecting unit 114 may select the representative joint on the basis of information obtained from another device through the input unit 21 or the communicating unit 23.

The output control unit 115 controls information output by the output unit 22.

In the present embodiment, the output control unit 115 controls a process of displaying, on a screen of the display unit 52, information about a result of evaluation made by the evaluating unit 113.

Here, although the present embodiment describes that the information processing device 1 processes a moving image captured by the image-capturing unit 25, the information processing device 1 may process a moving image obtained from another device through the input unit 21 or the communicating unit 23, as another example. In this case, the information processing device 1 may not include the image-capturing unit 25.

This another device may be an image capturing device such as a camera, or may be a computer including an image capturing device such as a camera, for example.

In addition, although the present embodiment describes that the information processing device 1 processes information such as a moving image in a form of digital data, a portion of or all of the target of processing may be in a form of analog signal.

Furthermore, in the present embodiment, a user represents a person who operates the information processing device 1 and views information outputted through display or the like by the information processing device 1.

For example, this user may be a target person seen in at least one moving image serving as a target of process by the evaluating unit 113, or may be a person who is not seen in any moving image serving as a target of process by the evaluating unit 113. In other words, it may be possible to employ a configuration in which this user causes the information processing device 1 to process a moving image in which the user itself is seen, or a configuration in which the user causes the information processing device 1 to process a moving image in which this user itself is not seen and another person is seen, or a configuration in which the user causes the information processing device 1 to perform both of these processes.

In addition, the present embodiment describes that the information processing device 1 is, for example, a smartphone that can be carried by a user. However, it may be possible to use a device installed in a fixed manner at a predetermined location such as a sports facility to capture a moving image of a target person who uses the facility, thereby processing the captured moving image, as another example.

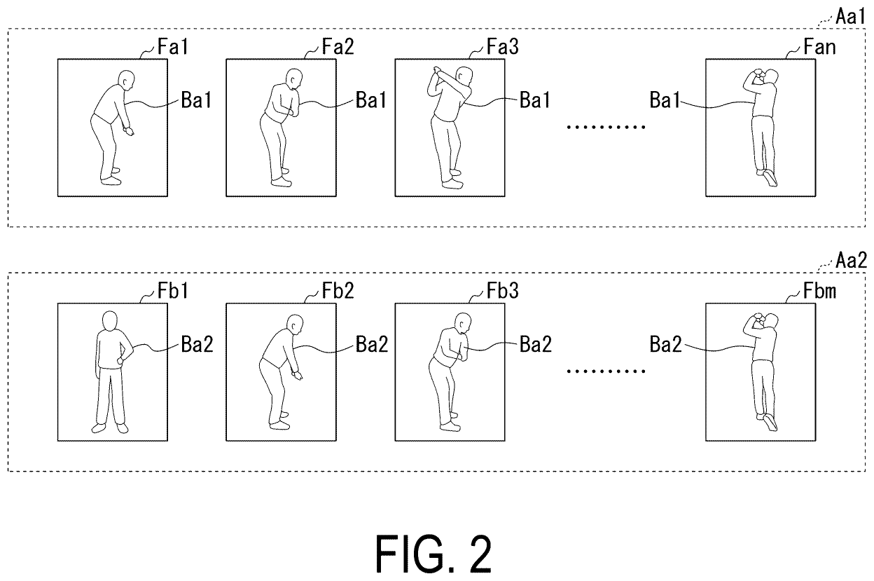

The process performed by the information processing device 1 will be schematically described with reference to FIG. 2.

FIG. 2 is a diagram illustrating one example of two moving images according to the embodiment.

FIG. 2 illustrates an a1-th moving image Aa1 and an a2-th moving image Aa2 as two moving images.

Here, in the present embodiment, two moving images that are compared with each other are designated in advance by a user of the information processing device 1, for example. In these two moving images, the same type of motion performed by different target persons or by the same target person is seen, for example. There is no limitation as to the same type of motion. For example, the motion includes a motion in which a series of movements such as golf swing is fixed and deviation of movements occurs depending on persons.

Note that another example includes a configuration in which the information processing device 1 automatically selects two moving images serving as the target of comparison through a processing flow that is determined in advance.

In addition, two moving images that are compared with each other may be separated into a moving image serving as a reference of comparison, and a moving image to be evaluated with respect to the moving image serving as the reference of comparison, or may not be separated in this manner, for example. The moving image serving as the reference of comparison may also be referred to as a comparative moving image or a reference moving image, for example.

Furthermore, the moving image to be evaluated may also be referred to as an evaluation-target moving image, for example.

The a1-th moving image Aa1 includes an a1-th frame Fa1 to an an-th frame Fan that are a plurality (of n pieces) of frames.

An a1-th target person Ba1 is seen in the a1-th frame Fa1 to the an-th frame Fan of the a1-th moving image Aa1. The a2-th moving image Aa2 includes a b1-th frame Fb1 to a bm-th frame Fbm that are a plurality of (m pieces of) frames.

An a2-th target person Ba2 is seen in the b1-th frame Fb1 to the bm-th frame Fbm of the a2-th moving image Aa2.

Here, in the example illustrated in FIG. 2, the body of the a1-th target person Ba1 and the body of the a2-th target person Ba2 are illustrated in the individual frames, whereas tools used by these target persons are not illustrated. These tools are, for example, golf clubs.

Note that a frame that constitutes a motion image may also be referred to as an image frame or the like.

The acquiring unit 111 acquires the a1-th moving image Aa1 and the a2-th moving image Aa2. The a1-th moving image Aa1 serves as one example of a first moving image, and the a2-th moving image Aa2 serves as one example of a second moving image.

The extracting unit 112 extracts a first motion from the a1-th moving image Aa1, and extracts a second motion from the a2-th moving image Aa2. The motion of the a1-th target person Ba1 serves as one example of a first motion, and the motion of the a2-th target person Ba2 serves as one example of a second motion.

The evaluating unit 113 determines a plurality of frames of the a2-th moving image Aa2 in which a similarity of the second motion of the a2-th moving image Aa2 relative to the first motion of the a1-th moving image Aa1 is equal to or more than a predetermined value.

Here, each of the first motion and the second motion is a series of motions of which series of movements is identical every time, such as a golf swing motion, for example. In addition, for example, the first moving image may be a moving image based on a plurality of times of motions made by a target person, or may be a moving image obtained by averaging a plurality of times of similar motions performed by the same target person, or the like.

As a specific example, when the a1-th target person Ba1 performs a golf swing motion a plurality of times, a moving image based on results of these plurality of times of swings is used as the a1-th moving image Aa1. As one example, it may be possible to use, as the a1-th moving image Aa1, a simulation moving image obtained by averaging angles of each joint during these plurality of times of swings. These processes of averaging or the like may be performed by the control unit 26 or the acquiring unit 111 or the like, for example.

In this manner, as for the first moving image, it may be possible to use a moving image based on a result of one-time motion performed by a target person, or it may be possible to use a moving image based on results of a plurality of times of motions performed by a target person, for example.

Note that, here, the first moving image has been described. However, as for other moving images, it may be possible to similarly use a moving image based on a plurality of times of motions performed by a target person.

As one example, the number of frames differs between the a1-th moving image Aa1 and the a2-th moving image Aa2. In the example illustrated in FIG. 2, the number n of frames of the a1-th moving image Aa1 and the number m of frames of the a2-th moving image Aa2 differ from each other.

As another example, the a1-th moving image Aa1 and the a2-th moving image Aa2 have the same number of frames.

Note that, in the present embodiment, for the purpose of convenience of explanation, description will be made on the assumption that frame rates are same between two moving images, that is, the number of frames per unit time is equal between these two moving images, by way of example. In addition, the present embodiment will make description on the assumption that, in a plurality of frames that constitute each moving image, a time difference between two frames temporally adjacent to each other is constant, that is, these plural frames are arranged at equal intervals in terms of time.

As another example, when frame rates or the like are different between two moving images that are compared with each other, the extracting unit 112 or the evaluating unit 113 may perform a process of aligning the frame rates of these two moving images to align the time intervals between a plurality of frames that constitute each moving image, for example. In this case, after the process described above, the evaluating unit 113 performs a process for synchronizing these two moving images. There is no particular limitation as to a method of aligning frame rates of two moving images. For example, it may be possible to use a method of reducing frames of a moving image having a higher frame rate or the like to reduce the number of frames, or a method of inserting a frame into a moving image having a lower frame rate or the like to increase the number of frames.

In the present embodiment, two moving images are following moving images, as one example.

The a1-th moving image Aa1 is a moving image obtained by capturing a first motion of the a1-th target person Ba1.

The a2-th moving image Aa2 is a moving image obtained by capturing a second motion of the a2-th target person Ba2.

Here, the a1-th target person Ba1 and the a2-th target person Ba2 are different humans.

As another example, two moving images may be the following moving images.

That is, the a1-th moving image Aa1 is a moving image obtained by capturing a first motion of the a1-th target person Ba1.

In addition, the a2-th moving image Aa2 is a moving image obtained by capturing a second motion of the a1-th target person Ba1.

In this case, the a2-th moving image Aa2 is a moving image captured before the a1-th moving image Aa1, as one example. As another example, the a2-th moving image Aa2 is a moving image captured after the a1-th moving image Aa1.

In addition, in this case, in the example illustrated in FIG. 2, the a2-th target person Ba2 and the a1-th target person Ba1 are the same human.

For example, the “similarity” represents a coefficient indicating a correlation between data regarding a first motion and data regarding a second motion.

This coefficient may also be referred to as a correlation coefficient, for example.

Here, any given method may be used as a method of calculating the similarity. For example, it may be possible to employ a method of calculating a Pearson product-moment correlation coefficient as the similarity, or employ a method of calculating another coefficient as the similarity.

Note that the similarity may also be referred to as a degree of similarity, or may also be referred to as a degree of correlation or level of agreement, for example. Furthermore, instead of the similarity, a dissimilarity may be used. That is, there is a correlation between them such that dissimilarity reduces with increase in the similarity and dissimilarity increase with decrease in the similarity.

In addition, the present embodiment describes that the similarity increases with increase in the value of coefficient indicating the similarity. However, as another example, it may be possible to use a coefficient indicating that the similarity increases with decrease in the value of the coefficient indicating the similarity.

For example, the evaluating unit 113 determines a plurality of frames of an a2-th moving image Aa2 in which a similarity of the second motion of the a2-th moving image Aa2 relative to the first motion of the a1-th moving image Aa1 is the highest.

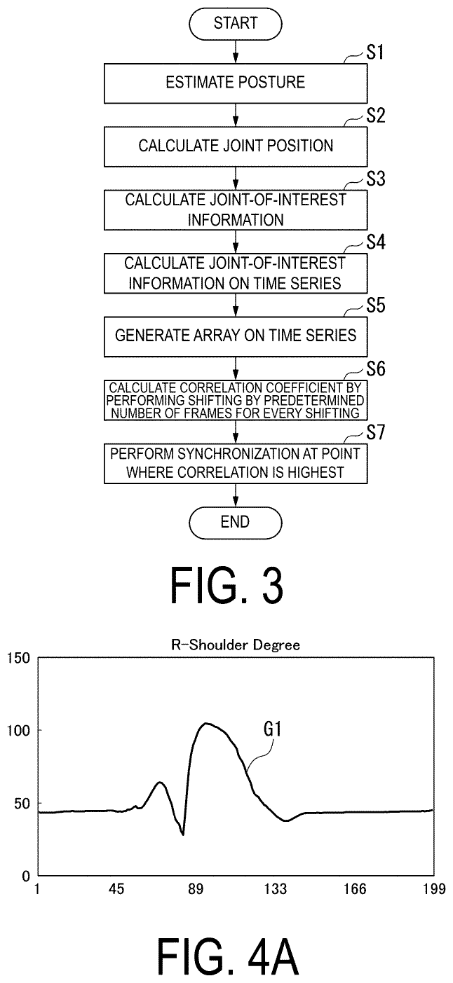

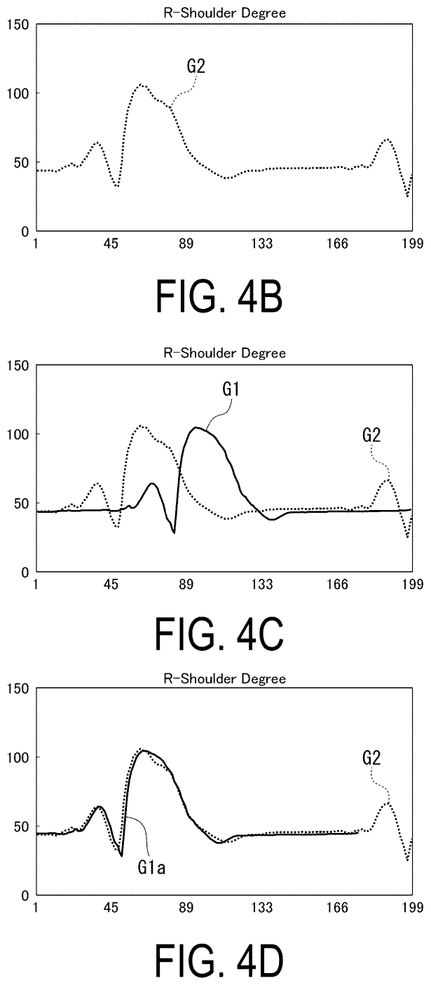

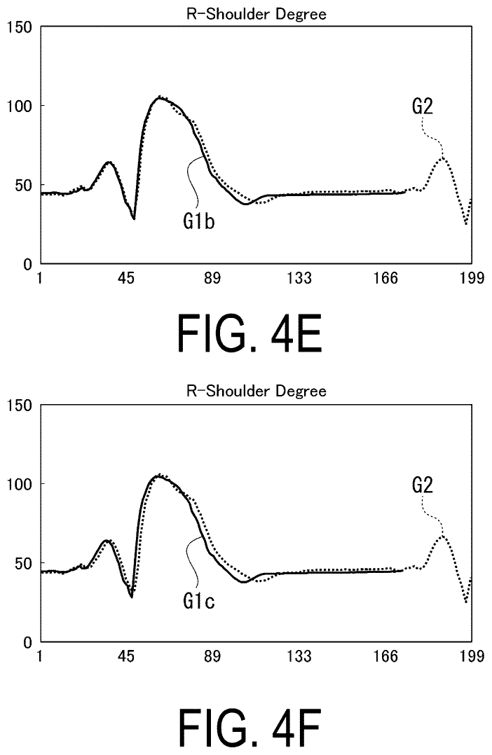

With reference to FIG. 3 and FIGS. 4A to 4F, there is indicated an example of a process of performing evaluation on the basis of joint information serving as information regarding a joint.

In the present embodiment, the evaluating unit 113 performs predetermined image processing to a moving image in which a target person is seen, thereby determining joint information regarding this target person.

Note that determination of the joint information may also be referred to as identifying of the joint information or detection of the joint information or the like, for example.

FIG. 3 is a diagram illustrating one example of a procedure of a process of performing evaluation on the basis of joint information in the information processing device 1 according to the embodiment.

In the example of the process flow illustrated in FIG. 3, processes from step S1 to step S5 are performed to two different moving images. In the present example, description will be made by referring to these two moving images as a first moving image and a second moving image.

Here, the first motion of the first target person is seen in a portion of or all of a plurality of frames that the first moving image has.

In addition, the second motion of the second target person is seen in a portion of or all of a plurality of frames that the second moving image has.

Note that the first target person and the second target person are different humans as one example. However, the first target person and the second target person may be the same human, as another example.

In the example illustrated in FIG. 3, the first moving image and the second moving image are acquired by the acquiring unit 111 before the process of step S1 is performed. The first motion is extracted from the first moving image by the extracting unit 112, and the second motion is extracted from the second moving image.

Furthermore, the processes of step S1 to step S5 are performed to each of the first moving image and the second moving image.

Here, the process for the first moving image and the process for the second moving image may be performed, for example, such that the processes of step S1 to step S5 are performed to one of the moving images, and then, the processes of step S1 to step S5 are performed to the other one of the moving images. Alternatively, the processes may be performed to two moving images concurrently in a time division manner.

Here, with the first moving image being used as a representative, description will be made of the processes of step S1 to step S5 performed to the first moving image.

In the process of step S1, the information processing device 1 is configured such that the evaluating unit 113 estimates the posture of the first target person that performs the first motion, on the basis of the first moving image. Then, the information processing device 1 moves to the process of step S2.

Note that, as for the method of estimating the posture of a human, any given method may be used. For example, a known method may be used.

Note that the “estimate” may also be referred to as “calculate”, “determine”, “identify”, or the like, for example. In addition, the “posture” may also be referred to as a “body position”, “form”, or the like, for example.

In the process of step S2, the information processing device 1 is configured such that the evaluating unit 113 calculates the joint position of the first target person, on the basis of a result of estimation of the posture of the first target person. Then, the information processing device 1 moves the process of step S3.

Note that, as for the method of calculating the joint position of a human, any given method may be used. For example, a known method may be used.

Here, there is no particular limitation as to a joint position serving as the target of calculation. For example, one or more joints of a human are set in advance, and the positions of the joints set in advance are used as the target of calculation. Alternately, positions of any one or more joints may be calculated through predetermined image processing, and in this case, the thus calculated positions of the joints are regarded as the joint positions serving as the target of calculation.

In the process of step S3, the information processing device 1 is configured such that the evaluating unit 113 calculates joint-of-interest information on the basis of a result of calculation of the joint position of the first target person. Then, the information processing device 1 moves to the process of step S4.

Note that, in the present embodiment, the joint-of-interest information serves as one example of the representative joint information.

Here, the joint-of-interest information represents information about a joint, and represents information to be focused on.

For example, the joint-of-interest information may include information regarding the position itself of one or more joints, or may not include this information. In addition, the joint-of-interest information may include one or more of information regarding predetermined angles of one or more joints, information regarding the distance between positions of two different joints, information regarding a deviation between predetermined angles of two different joints, and the like.

As for the predetermined angle of a joint, it may be possible to use an angle defined for each joint on the basis of the structure of a human, for example. As a specific example, it may be possible to use, as this angle, an angle around the axis of any one of the X-axis, the Y-axis, and the Z-axis when a XYZ orthogonal coordinate axes that are three-dimensional orthogonal coordinate axes are set for this human, and it may be possible to use an angle around the other direction.

Note that types of information used as the joint-of-interest information may be set in advance, for example. As for the joint-of-interest information, it may be possible to use information in which a feature appears most in a posture desired to be checked in sports or the like.

Here, the present embodiment describes the process of step S2 of calculating the joint position and the process of step S3 of calculating the joint-of-interest information. However, for example, when a result of calculation of the joint position is used as the joint-of-interest information, it may be possible to combine the process of step S2 and the process of step S3 into one process.

In the process of step S4, the information processing device 1 is configured such that the evaluating unit 113 calculates the joint-of-interest information on a time series. Then, the information processing device 1 moves to the process of step S5.

Here, as for the joint-of-interest information on a time series, it may be possible to use information including a plurality of values that follow the flow of time, with respect to the same joint-of-interest information in which a value can change with time. For example, the “flow of time” may be a flow in a direction in which the time moves into the future, or may be a flow in a direction in which the time goes back toward the past.

In addition, as for the plurality of values that follow the flow of time, it may be possible to use a value for each of a plurality of consecutive frames, or use a value for every two or more frames selected in a discrete manner from among a plurality of consecutive frames, for example.

There is no particular limitation as to the method of selecting two or more frames in a discrete manner from among a plurality of consecutive frames. For example, it may be possible to use a method of selecting a frame for every predetermined number of frames, such as for every other frame or for every three frames.

In the process of step S5, the information processing device 1 is configured such that the evaluating unit 113 generates an array on a time series on the basis of the calculated joint-of-interest information on a time series.

Here, as for the array on a time series, it may be possible to use an array in which a plurality of values on a time series that constitute the calculated joint-of-interest information on a time series are arranged on a time series in a storage region of a memory, the array being the target of processing performed by a processor of the information processing device 1, for example. As for this memory, it may be possible to use a memory that the storage unit 24 has, for example.

Here, the present embodiment describes the process of step S4 of calculating the joint-of-interest information on a time series and the process of step S5 of generating an array on a time series. However, for example, when the array on a time series is generate at the same time when the joint-of-interest information on a time series is calculated, it may be possible to combine the process of step S4 and the process of step S5 into one process.

These are descriptions of the processes of step S1 to step S5 performed to the first moving image by using the first moving image as a representative. However, the information processing device 1 also performs the processes of step S1 to step S5 to the second moving image.

Here, for the first moving image and the second moving image, the evaluating unit 113 calculates one or more pieces of joint-of-interest information on the same joint-of-interest information that can have different values.

In addition, the information processing device 1 moves to the process of step S6.

In the process of step S6, the information processing device 1 is configured such that the evaluating unit 113 calculates a correlation coefficient between information obtained from the first moving image and information obtained from the second moving image in terms of the same joint-of-interest information. In this case, the evaluating unit 113 shifts each of these two pieces of information by a predetermined number of frames to calculate this correlation coefficient at every shifting. In addition, the evaluating unit 113 calculates this correlation coefficient for predetermined one or more pieces of joint-of-interest information. Then, the information processing device 1 moves to the process of step S7.

Here, there is no particular limitation as to the predetermined number of frames, and it may be possible to use a “1”, “2”, or other values, for example.

Furthermore, there is no particular limitation as to the correlation coefficient between two pieces of information. For example, it may be possible to use any given value indicating the similarity between these two pieces of information.

In the process of step S7, the information processing device 1 is configured such that the evaluating unit 113 performs a process of synchronizing these two pieces of information at a point at which a correlation between information obtained from the first moving image and information obtained from the second moving image is the highest, on the basis of a result of calculation of the correlation coefficient. Then, the information processing device 1 ends the process of the present process flow.

Here, for example, it may be possible to determine the point at which the correlation between information obtained from the first moving image and information obtained from the second moving image is the highest, on the basis of one piece of joint-of-interest information, or determine this point on the basis of two or more pieces of joint-of-interest information. In this case, it may be possible to determine the point at which the correlation is the highest, on the basis of an average value concerning two or more pieces of joint-of-interest information, or on the basis of the median, or the like.

Furthermore, as for the process of synchronizing information obtained from the first moving image and information obtained from the second moving image, it may be possible to employ a process of determining the number of shifting of frames when frames of the two moving images are shifted so as to maximize the correlation between these two pieces of information, for example.

In addition, when a plurality of pieces of different joint information can be obtained from a common moving image such as the first moving image or the second moving image, it may be possible to perform a process of separately taking synchronization for these plurality of pieces of joint information. Alternatively, it may be possible to perform a process of taking synchronization on the basis of one or more of a portion of the joint information from among these plurality of pieces of joint information, and taking synchronization of another joint information so as to match the timing of the synchronization described above, for example.

With reference to FIGS. 4A to 4F, description will be made of a correlation between two pieces of information with respect to the same joint-of-interest information.

In the example illustrated in FIGS. 4A to 4F, information regarding a predetermined angle (R-Shoulder Degrees) of the right shoulder of a human is used as the joint-of-interest information. As for the predetermined angle, an angle with respect to the right shoulder is defined in advance.

These two pieces of information include information obtained from the first motion of the first moving image and information obtained from the second motion of the second moving image, both of these pieces of information relating to the same joint-of-interest information. Here, for the purpose of convenience of explanation, description will be made such that these two pieces of information are referred to as first information and second information.

Here, in the present embodiment, joint information such as these two pieces of information is configured as data having a waveform, for example. Specifically, the joint information is configured as data in which a value can change as time goes. Note that, in the present embodiment, data having such a waveform is digital data. Strictly speaking, this data is comprised of a value at discrete timing in a direction in which time advances. However, the drawing gives illustration using a display mode in which the data can be seen so as to have a continuous waveform, for the purpose of facilitating viewing.

Note that the joint information is not necessarily regarded as data having a waveform. For example, the joint information may be regarded as data in which a plurality of numerical values are arranged.

In the graph illustrated in each of FIGS. 4A to 4F, the horizontal axis indicates the time, and the vertical axis indicates values of joint-of-interest information.

Here, the unit of time of a clock may not be necessarily used for the unit of time in this horizontal direction. For example, a frame number corresponding to the time may be used.

In addition, there is no particular limitation as to the unit of the value in the vertical axis. Any unit of a level may be used.

FIG. 4A is a diagram illustrating one example of the joint-of-interest information according to the embodiment.

The joint-of-interest information is first information G1 obtained from the first motion of the first moving image.

FIG. 4B is a diagram illustrating another example of the joint-of-interest information according to the embodiment.

This joint-of-interest information is second information G2 obtained from the second motion of the second moving image.

FIG. 4C is a diagram illustrating an example of two pieces of information about the same joint-of-interest information according to the embodiment.

FIG. 4C illustrates the first information G1 illustrated in FIG. 4A and the second information G2 illustrated in FIG. 4B.

In the state illustrated in FIG. 4C, the evaluating unit 113 calculates that the correlation coefficient between the first information G1 and the second information G2 is 0.35.

FIG. 4D is a diagram illustrating one example of a result obtained by shifting relative timing of two pieces of information about the same joint-of-interest information according to the embodiment.

FIG. 4D illustrates the second information G2 illustrated in FIG. 4B, and also illustrates 1a-th information G1a that is a result obtained by shifting the first information G1 illustrated in FIG. 4A by several frames toward the left direction in the horizontal direction of the graph relative to the state of FIG. 4C. In the present example, shifting toward the left direction in this horizontal axis corresponds to temporally going backward toward the past.

In the state illustrated in FIG. 4D, the evaluating unit 113 calculates that the correlation coefficient between the 1a-th information G1a and the second information G2 is 0.86.

Note that, in the process of step S6 in the process flow illustrated in FIG. 3, the first information G1 illustrated in FIG. 4A is shifted by one frame every time. However, during a change from the example of FIG. 4C to the example of FIG. 4D, the middle processes are not illustrated, and illustration is only given of a case in which shifting is performed only by several frames.

FIG. 4E is a diagram illustrating another example of a result obtained by shifting relative timing of two pieces of information about the same joint-of-interest information according to the embodiment.

FIG. 4E illustrates the second information G2 illustrated in FIG. 4B, and also illustrates 1b-th information G1b that is a result obtained by further shifting, from the state of FIG. 4D, the first information G1 illustrated in FIG. 4A by only one frame toward the left direction in the horizontal direction of the graph.

In the state illustrated in FIG. 4E, the evaluating unit 113 calculates that the correlation coefficient between the 1b-th information G1b and the second information G2 is 0.98.

FIG. 4F is a diagram illustrating another example of a result obtained by shifting relative timing of two pieces of information about the same joint-of-interest information according to the embodiment.

FIG. 4F illustrates the second information G2 illustrated in FIG. 4B, and also illustrates 1c-th information G1c that is a result obtained by further shifting, from the state of FIG. 4E, the first information G1 illustrated in FIG. 4A by only one frame toward the left direction in the horizontal direction of the graph.

In the state illustrated in FIG. 4F, the evaluating unit 113 calculates that the correlation coefficient between the 1c-th information G1c and the second information G2 is 0.88.

Here, the evaluating unit 113 determines that, at the relative timing illustrated in FIG. 4E, the correlation coefficient is the highest and the correlation between the two pieces of information is the highest, on the basis of the correlation coefficients at the individual relative timings in FIG. 4D, FIG. 4E, and FIG. 4F.

Note that, here, for the purpose of simplifying explanation, description has been made of a case of calculating the correlation coefficient while relatively shifting frames in two pieces of information, and determining that the correlation between the two pieces of information is the highest at the point at which the correlation coefficient is at the peak. However, any given method may be used for the method of determining the point at which the correlation between the two pieces of information is the highest.

In addition, in terms of the time in the horizontal axis of the graph, the present example describes a case in which, of the first information G1 and the second information G2, the timing of the second information G2 is fixed and the timing of the first information G1 is shifted. However, conversely, it may be possible to employ a configuration in which the timing of the first information G1 is fixed and the timing of the second information G2 is shifted.

Furthermore, in terms of the time in the horizontal axis of the graph, the present example describes a case in which the timing of either one information of two pieces of information is fixed and the timing of the other information is shifted to change the relative timing of these two pieces of information. However, as another example, it may be possible to employ a case in which timings of both of these two pieces of information are shifted to change the relative timing of these two pieces of information.

For example, for each of a plurality of joints, the evaluating unit 113 determines a plurality of frames of the second moving image in which a similarity of the second motion of the second moving image relative to the first motion of the first moving image is equal to or more than a predetermined value.

Here, the information processing device 1 may be configured such that the selecting unit 114 selects, as the representative joint, a typical joint from among a plurality of joints on the basis of a predetermined rule or in response to an instruction given from a user, for example. In addition, in terms of the selected representative joint, the evaluating unit 113 may determine a point at which the correlation between two pieces of information is the highest, and may also apply the result of this determination to evaluation of other joints.

As one example, the evaluating unit 113 sets, as the representative joint, a joint having the highest similarity from among the plurality of joints, and sets the plurality of frames of the second moving image in which the similarity of this representative joint is the highest, to a plurality of frames for evaluating other joints.

As another example, the evaluating unit 113 sets, as the representative joint, a joint that a target person selects from among a plurality of joints, and sets the plurality of frames of the second moving image in which the similarity of this representative joint is the highest, to frames used to evaluate other joints.

Note that, in this case, in the present embodiment, this target person matches a user.

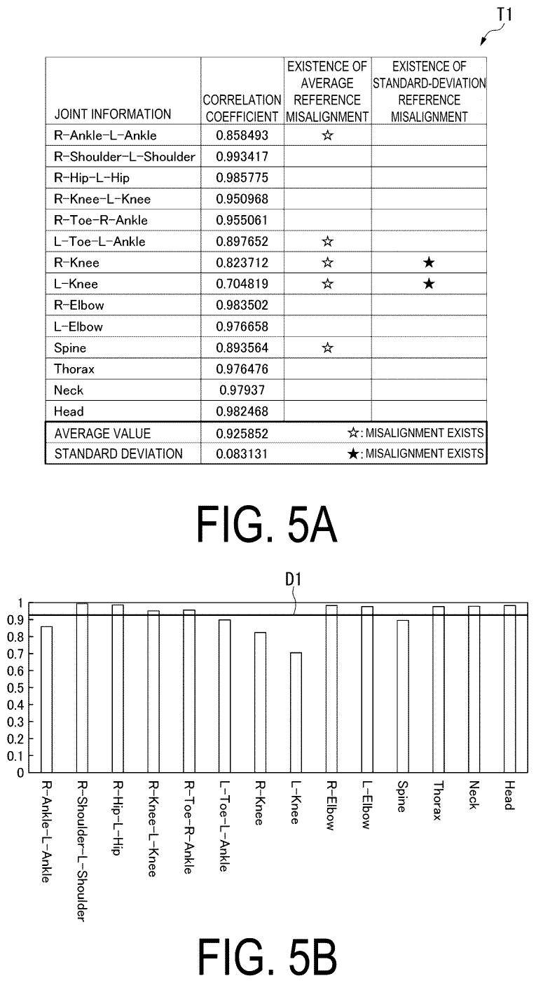

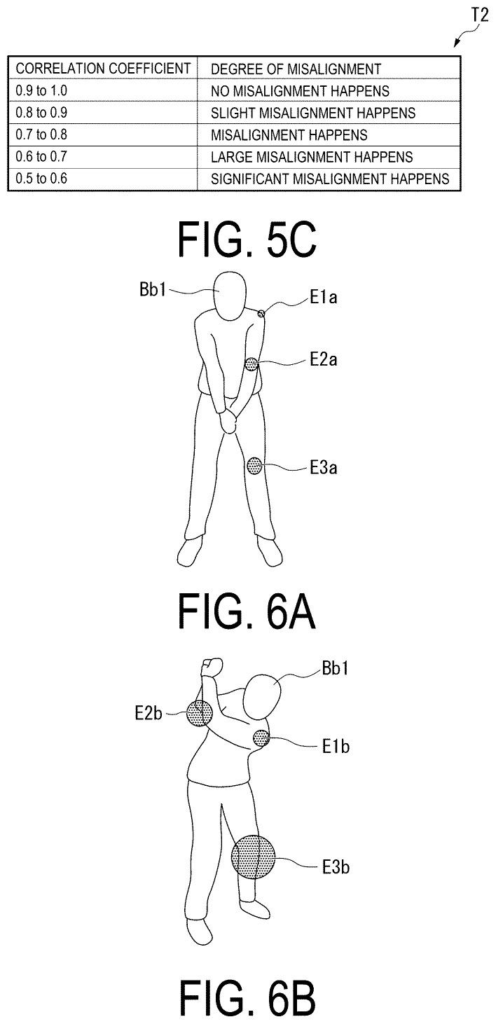

Misalignment of a joint will be described with reference to FIGS. 5A to 5C.

The example illustrated in FIGS. 5A to 5C shows joint information regarding 14 pieces of joints.

Specifically, the joint information includes: information (R-Ankle-L-Ankle) regarding a relationship between the right ankle and the left ankle; information (R-Shoulder-L-Shoulder) regarding a relationship between the right shoulder and the left shoulder; information (R-Hip-L-Hip) regarding a relationship between the right hip and the left hip; information (R-Knee-L-Knee) regarding a relationship between the right knee and the left knee; information (R-Toe-R-Ankle) regarding the right ankle; information (L-Toe-L-Ankle) regarding the left ankle; information (R-Knee) regarding the right knee; information (L-Knee) regarding the left knee; information (R-Elbow) regarding the right elbow; information (L-Elbow) regarding the left elbow; information (Spine) regarding the spine; information (Thorax) regarding the thorax; information (Neck) regarding the neck; and information (Head) regarding the head.

Note that these pieces of information regarding joints are given merely as an example, and it may be possible use various types of information for the joint information.

FIG. 5A is a diagram illustrating a first table T1 that holds information about a correlation coefficient for each joint information according to the embodiment.

The first table T1 shows a relationship between the joint information and the correlation coefficient. In the example in FIG. 5A, this correlation coefficient indicates a correlation coefficient at a point at which a correlation between the first information obtained from the first motion of the first moving image and the second information obtained from the second motion of the second moving image is the highest. Furthermore, in two lower rows, the first table T1 includes the average value of correlation coefficients and the standard deviation of correlation coefficient on 14 pieces of joint information.

In addition, the first table T1 includes a column of “existence of average reference misalignment” in which a white-star mark is attached to indicate a joint determined to be misaligned on the basis of the average value of correlation coefficients.

In the present example, the evaluating unit 113 determines the joint information having a correlation coefficient lower than the average value of correlation coefficients of all the joints servings as the target of evaluation, to be misaligned on the basis of the average reference.

In the example illustrated in FIG. 5A, the R-Ankle-L-Ankle, the L-Toe-L-Ankle, the R-Knee, the L-Knee, and the Spine are determined to be misaligned on the basis of the average standard.

In addition, the first table T1 includes a column of “existence of standard-deviation reference misalignment” in which a black-star mark is attached to indicate a joint determined to be misaligned on the basis of the standard deviation of correlation coefficients.

In the present example, the evaluating unit 113 determines the joint information having a correlation coefficient deviating from the standard deviation of correlation coefficients of all the joints servings as the target of evaluation, to be misaligned on the basis of the standard deviation reference. In the example illustrated in FIG. 5A, the R-Knee and the L-Knee are determined to be misaligned on the basis of the standard deviation reference.

FIG. 5B is a diagram illustrating a graph showing information about a correlation coefficient for each joint information according to the embodiment.

The graph in FIG. 5B indicates correlation coefficients illustrated in FIG. 5A on 14 pieces of joint information. The correlation coefficients of 14 pieces of joint information are each indicated on the horizontal axis direction of the graph, and values of the correlation coefficient of each joint information are indicated on the vertical axis of the graph.

In addition, the graph in FIG. 5B shows the average value D1 of the correlation coefficients illustrated in FIG. 5A.

Note that the example in FIG. 5B shows a case in which the average value D1 of the correlation coefficients is used. This similarly applies to a case in which the standard deviation of the correlation coefficients is used.

As another example, the evaluating unit 113 may determine the degree of misalignment for each joint information on the basis of a correspondence between the degree of misalignment and the predetermined correlation coefficient. In addition, with the output unit 22, the output control unit 115 may provide information regarding the degree of misalignment of each joint information.

Note that the degree of misalignment may be referred to as the level of misalignment, the magnitude of misalignment, or the like, for example.

FIG. 5C is a diagram illustrating a second table T2 that holds one example of a relationship between the correlation coefficient and the degree of misalignment according to the embodiment.

Here, the information having such a relationship may be stored in the storage unit 24 in advance, for example.

The evaluating unit 113 determines the degree of misalignment from the correlation coefficient of each joint information on the basis of the information having the relationship described above.

In the example illustrated in FIG. 5C, it is determined that no misalignment happens when the correlation coefficient falls in a range of 0.9 to 1.0. It is determined that slight misalignment happens when the correlation coefficient falls in a range of 0.8 to 0.9. It is determined that misalignment happens when the correlation coefficient falls in a range of 0.7 to 0.8. It is determined that large misalignment happens when the correlation coefficient falls in a range of 0.6 to 0.7. It is determined that significant misalignment happens or measurement error occurs when the correlation coefficient falls in a range of 0.5 to 0.6.

Note that, when the correlation coefficient falls in a range of 0 to 0.5, determination may be made in a manner similar to a case in which the correlation coefficient falls in a range of 0.5 to 0.6, or a different result of determination may be associated in advance, for example.

Here, the example in FIG. 5C schematically shows a relationship between the correlation coefficient and the degree of misalignment, and more strict correspondence may be defined.

One example of a display mode of a target person and joints will be described with reference to FIGS. 6A and 6B.

Each of FIGS. 6A and 6B is a diagram illustrating one example of a display mode of a target person and joints according to the embodiment.

The output control unit 115 may control displaying information indicated in FIGS. 6A and 6B on a screen of the display unit 52.

FIGS. 6A and 6B schematically illustrate a body of a b1-th target person Bb1 serving as one example of a target person illustrated in a three-dimensional solid display. A picture of the b1-th target person Bb1 displayed in this manner may also be referred to as an avatar, for example.

In the example illustrated in FIG. 6A, the b1-th target person Bb1 holds a golf club and takes a posture at a ready position.

In the example illustrated in FIG. 6B, the b1-th target person Bb1 takes a posture of backswing with the golf club.

Note that the example of FIGS. 6A and 6B illustrates the body of the b1-th target person Bb1, and does not illustrate any tool used by the b1-th target person Bb1. This tool is, for example, a golf club.

The example in FIG. 6A uses a predetermined mark to indicate each of 1a-th joint information E1a, 2a-th joint information E2a, and 3a-th joint information E3a in the body of the b1-th target person Bb1.

Here, the 1a-th joint information E1a, the 2a-th joint information E2a, and the 3a-th joint information E3a each represent different joint information in the body of the b1-th target person Bb1.

Furthermore, the 1a-th joint information E1a, the 2a-th joint information E2a, and the 3a-th joint information E3a are each indicated at a position of a corresponding joint in the body of the b1-th target person Bb1.

In addition, this mark has a predetermined shape having a size corresponding to the degree of misalignment.

In the present example, the predetermined shape is a circle. As another example, it may be possible to use other shapes such as a quadrilateral shape, a triangle shape, or a star shape.

The size may increase with increase in the degree of misalignment, for example. The size may include the radius of a circle, the length of a side of a quadrilateral shape, or the like, for example.

It may be possible to use any color for the mark, and red may be possible, for example.

The example in FIG. 6B uses a predetermined mark to indicate each of 1b-th joint information E1b, 2b-th joint information E2b, and 3b-th joint information E3b in the body of the b1-th target person Bb1.

Here, the 1b-th joint information E1b, the 2b-th joint information E2b, and the 3b-th joint information E3b each represent the same joint information as the 1a-th joint information E1a, the 2a-th joint information E2a, and the 3a-th joint information E3a, respectively, and are indicated at similar positions in the body of the b1-th target person Bb1.

In this manner, the output control unit 115 may cause a predetermined mark representing the degree of misalignment to be displayed at a position of each joint of the b1-th target person Bb1 in an overlapping manner.

For example, the degree of misalignment may be determined on the basis of the information illustrated in FIGS. 5A and 5B, or may be determined on the basis of the information in the second table T2 illustrated in FIG. 5C. Alternatively, it may be possible to use other methods to make determination. In the present embodiment, the evaluating unit 113 determines this degree of misalignment.

In addition, as in the example in FIGS. 6A and 6B, the evaluating unit 113 may perform evaluation as to data regarding temporal movement of a predetermined joint, and the output control unit 115 may provide, over time, an error or the like of data regarding temporal movement of this joint.

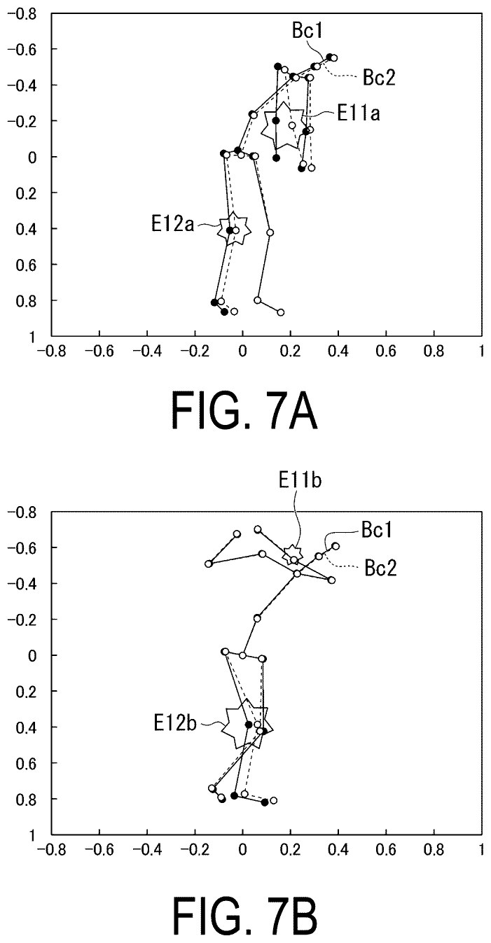

One example of a display mode of bones and joints of a target person will be described with reference to FIGS. 7A and 7B.

Each of FIGS. 7A and 7B is a diagram illustrating one example of a display mode of bones and joints of a target person according to the embodiment.

The output control unit 115 may control displaying information indicated in FIGS. 7A and 7B on a screen of the display unit 52.

FIGS. 7A and 7B illustrate a body of a c1-th target person Bc1 and a c2-th target person Bc2 serving as an example of a target person illustrated using bones and joints.

Note that, in FIGS. 7A and 7B, scales on the horizontal axis and scales on the vertical axis are each indicated as a reference. These scales may be scales of a coordinate system with the center being the center of gravity or the like of the c1-th target person Bc1 or the c2-th target person Bc2, for example.

In the example illustrated in FIGS. 7A and 7B, bones are illustrated as lines, and joints are illustrated as round marks.

Here, the example illustrated in FIGS. 7A and 7B illustrates bones and joints of the c1-th target person Bc1 and the c2-th target person Bc2. However, tools used by these target persons are not illustrated in these drawings. The tools are, for example, golf clubs.

Note that, as for the mode for displaying information indicating bones and joints of a human serving as a target person, it may be possible to employ a mode in which not all the bones and joints of a human are accurately displayed, for example, a mode in which only a portion of bones and joints are displayed. Alternatively, it may be possible to employ a mode in which the accuracy is reduced to some degree to display bones and joints in a schematic manner in order to facilitate understanding for a user who views the display screen.

Here, the c1-th target person Bc1 and the c2-th target person Bc2 are target persons that are compared with each other. For example, these persons may be different humans, or may be the same human.

When the c1-th target person Bc1 and the c2-th target person Bc2 are the same target person, the c1-th target person Bc1 and the c2-th target person Bc2 show motions that are performed by the same target person at different times.

In the present example, the display control unit 115 displays the degree of misalignment between the joint information of the c1-th target person Bc1 and the joint information of the c2-th target person Bc2.

In the example in FIG. 7A, the c1-th target person Bc1 and the c2-th target person Bc2 each hold a golf club and take a posture at a ready position.

In the example illustrated in FIG. 7B, the c1-th target person Bc1 and the c2-th target person Bc2 take a posture of backswing with the golf club.

The example in FIG. 7A uses a predetermined mark to indicate each of 11a-th joint information E11a and 12a-th joint information E12a in the c1-th target person Bc1 and the c2-th target person Bc2.

Here, the 11a-th joint information E11a and the 12a-th joint information E12a are different pieces of joint information.

In addition, the 11a-th joint information Ella and the 12a-th joint information E12a are indicated at positions of associated joints.

In addition, this mark has a predetermined shape having a size corresponding to the degree of misalignment.

In the present example, the predetermined shape is a star shape. As another example, it may be possible to use other shapes such as a circle, a quadrilateral shape, or a triangle shape.

The size may increase with increase in the degree of misalignment, for example.

This mark has any given color, and yellow or the like may be used, for example.

The example in FIG. 7B uses a predetermined mark to indicate each of 11b-th joint information E11b and 12b-th joint information E12b in the c1-th target person Bc1 and the c2-th target person Bc2.

Here, the 11b-th joint information E11b and the 12b-th joint information E12b each represent the same joint information as the 11a-th joint information Ella and the 12a-th joint information E12a, respectively, and are indicated at similar positions.

In this manner, the output control unit 115 may cause a predetermined mark representing the degree of misalignment to be displayed at a position of each joint of the c1-th target person Bc1 and the c2-th target person Bc2 in an overlapping manner.

For example, the degree of misalignment may be determined on the basis of the information illustrated in FIGS. 5A and 5B, or may be determined on the basis of the information in the second table T2 illustrated in FIG. 5C. Alternatively, it may be possible to use other methods to make determination. In the present embodiment, the evaluating unit 113 determines this degree of misalignment.

In addition, as in the example in FIGS. 7A and 7B, the evaluating unit 113 may perform evaluation as to data regarding temporal movement of a predetermined joint, and the output control unit 115 may provide, over time, an error or the like of data regarding temporal movement of this joint.

The evaluating unit 113 evaluates the second motion relative to the first motion for a plurality of frames of the second moving image in which a similarity of the second motion of the second moving image relative to the first motion of the first moving image is equal to or more than a predetermined value.

The evaluating unit 113 uses data indicating a motion of each joint in the second motion relative to data indicating a motion of each joint in the first motion, to evaluate the second motion relative to the first motion.

For example, when the similarity of one joint is lower than an average value of similarities of a plurality of joints including similarities of the other joints or deviates from the standard deviation of similarities of a plurality of joints including similarities of the other joints, the evaluating unit 113 determines that misalignment happens.

Here, the similarities of the plurality of joints including similarities of other joints may include the similarity of this one joint or may not include the similarity of this one joint, for example.

The evaluating unit 113 evaluates data regarding temporal movement of a joint.

The output unit 22 outputs different information depending on whether an error of data regarding temporal movement of a joint is large or small.

In this manner, the information processing device 1 may notify a user or the like of evaluation on data regarding temporal movement of a joint.

Here, as for the different information depending on an error, various types of information may be used. For example, it may be possible to use information having a different predetermined length of a predetermined shape such as the size of the radius of a circle, for example.

In addition, the output unit 22 shows, over time, data regarding temporal movement of a joint, for example.

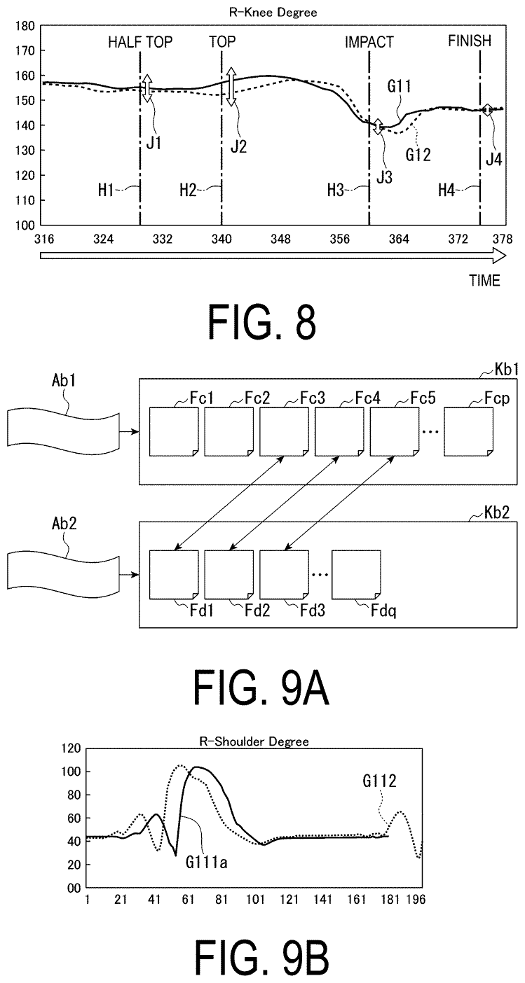

FIG. 8 is a diagram illustrating one example of a display mode of a variation in joints according to the embodiment.

The output control unit 115 may control displaying information illustrated in FIG. 8, on a screen of the display unit 52.

In the graph illustrated in FIG. 8, the horizontal axis indicates the time, and the vertical axis indicates values of predetermined joint information on a time series.

The example illustrated in FIG. 8 uses information regarding a predetermined angle (R-Knee Degree) of the right knee as the joint information.

The example illustrated in FIG. 8 illustrates eleventh information G11 and twelfth information G12 as information obtained from two moving images.

In addition, the example in FIG. 8 illustrates first key timing H1 to fourth key timing H4 with respect to the time on the horizontal axis.

Here, the first key timing H1 to the fourth key timing H4 each indicate timings of key postures during golf swing, and correspond to half top, top, impact, and finish, respectively.

In addition, in the example illustrated in FIG. 8, deviations between the eleventh information G11 and the twelfth information G12 at the first key timing H1 to the fourth key timing H4 are indicated as a first deviation J1 to a fourth deviation J4, respectively.

The first deviation J1 to the fourth deviation J4 are each indicated by using an arrow. In addition, the length of this arrow is, for example, proportional to and corresponds to the size of the deviation.

With this configuration, variations in joint information are illustrated by the arrows on a time series.

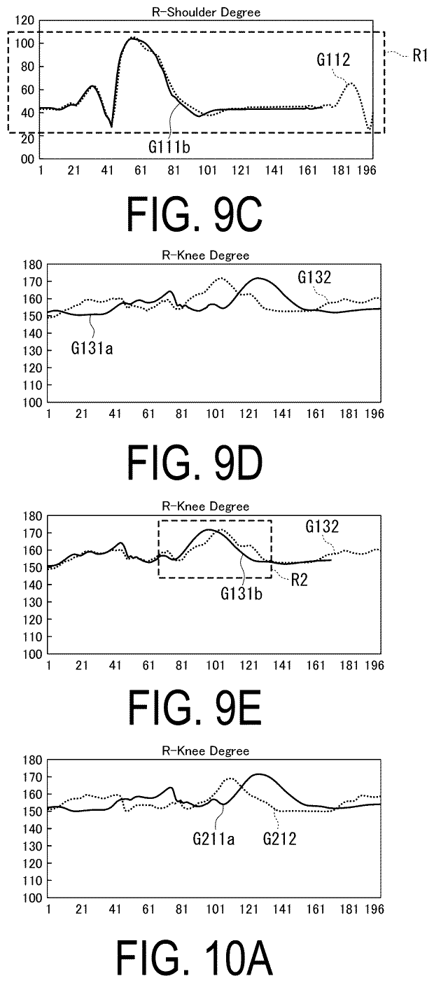

With reference to FIGS. 9A to 9E, description will be made of an example of a process of synchronizing frames of two moving images on the basis of information about a joint to perform evaluation for each joint.

FIG. 9A is a diagram illustrating one example of information about two moving images according to the embodiment.

In the example illustrated in FIG. 9A, the two moving images are a b1-th moving image Ab1 and a b2-th moving image Ab2.

The evaluating unit 113 generates a b1-th frame group Kb1 concerning information regarding a predetermined joint position on the basis of the b1-th moving image Ab1.

The b1-th frame group Kb1 includes a c1-th frame Fc1 to a cp-th frame Fcp that are a plurality (p pieces) of frames. Each of the frames includes a motion of a target person, and also includes information in which a value can change in terms of the same joint position.

Similarly, the evaluating unit 113 generates a b2-th frame group Kb2 concerning information regarding a predetermined joint position on the basis of the b2-th moving image Ab2.

The b2-th frame group Kb2 includes a d1-th frame Fd1 to a dq-th frame Fdq that are a plurality (q pieces) of frames. Each of the frames includes a motion of a target person, and also includes information in which a value can change in terms of the same joint position.

Here, as one example, the number p of frames that the b1-th frame group Kb1 includes and the number q of frames that the b2-th frame group Kb2 includes differ from each other. As another example, both numbers may be the same.

The example illustrated in FIG. 9A relates to predetermined joint information, and schematically illustrates that the c3-th frame Fc3, the c4-th frame Fc4, and the c5-th frame Fc5 of the b1-th moving image Ab1 are synchronized with the d1-th frame Fd1, the d2-th frame Fd2, and the d3-th frame Fd3 of the b2-th moving image Ab2. In the present embodiment, the evaluating unit 113 takes such synchronization.

Note that, in the example illustrated in FIG. 9A, details of an image of each frame are not illustrated. However, details of the image are similar to those in the example in FIG. 2 in a schematic manner, and a target person seen in the image, the motion of this target person, and the like may be different.

In the present example, the b1-th moving image Ab1 and the b2-th moving image Ab2 include a position of a joint of the right shoulder and a position of a joint of the right knee as the predetermined joint position.

Thus, the information as illustrated in FIG. 9A can be obtained for each of the position of the joint of the right shoulder and the position of the joint of the right knee.

FIG. 9B is a diagram illustrating one example of two pieces of information about a joint of the right shoulder according to the embodiment. In the present example, these two pieces of information are information regarding the joint of the right shoulder and a predetermined angle.

In the graph illustrated in FIG. 9B, the horizontal axis indicates the time, and the vertical axis indicates values of predetermined joint information.

In the example illustrated in FIG. 9B, these two pieces of information are 111a-th information G111a and 112-th information G112.

The 111a-th information G111a is information about the joint of the right shoulder obtained from the b1-th moving image Ab1.

The 112-th information G112 is information about the joint of the right shoulder obtained from the b2-th moving image Ab2.

The example illustrated in FIG. 9B illustrates these two pieces of information in a state in which timings of these pieces of information are not adjusted in terms of the time on the horizontal axis. In other words, in the example illustrated in FIG. 9B, these two pieces of information are not synchronized with each other.

FIG. 9C is a diagram illustrating one example of a result obtained by shifting relative timing of two pieces of information about the joint of the right shoulder according to the embodiment.

In the graph illustrated in each of FIG. 9C, the horizontal axis indicates the time, and the vertical axis indicates values of joint information.

The example illustrated in FIG. 9C illustrates a state in which, while the timing of the 112-th information G112 remains fixed, the timing of the 111a-th information G111a is shifted to make it adjusted to the 111b-th information G111b, whereby the 112-th information G112 and the 111b-th information G111b are most synchronized.

Here, in the present example, the evaluating unit 113 synchronizes two pieces of information about the joint of the right shoulder such that the correlation coefficient during a change on a time series is the highest.

In the example illustrated in FIG. 9C, two pieces of information substantially match each other in a first region R1 during a predetermined period.

As a specific example, when a motion of golf swing is seen in each of the b1-th moving image Ab1 and the b2-th moving image Ab2 when the same target person differs, and the information about the joint of the right shoulder is information about the angle or the position or the like of the shoulder joint, determination is made such that, in the first region R1, the two swings are substantially similar to each other in terms of the motion of the right shoulder joint.

FIG. 9D is a diagram illustrating one example of two pieces of information about a joint of the right knee according to the embodiment. In the present example, the two pieces of information relate to information about a predetermined angle of the joint of the right knee.

In the graph illustrated in FIG. 9D, the horizontal axis indicates the time, and the vertical axis indicates values of joint information.

In the example illustrated in FIG. 9D, these two pieces of information are 131a-th information G131a and 132-th information G132.

The 131a-th information G131a is information about the joint of the right knee obtained from the b1-th moving image Ab1.

The 132-th information G132 is information about the joint of the right knee obtained from the b2-th moving image Ab2.

The example illustrated in FIG. 9D illustrates these two pieces of information in a state in which timings of these pieces of information are not adjusted in terms of the time on the horizontal axis. In other words, in the example illustrated in FIG. 9D, these two pieces of information are not synchronized with each other.

FIG. 9E is a diagram illustrating one example of a result obtained by shifting relative timing of two pieces of information about the joint of the right knee according to the embodiment.

In the graph illustrated in FIG. 9E, the horizontal axis indicates the time, and the vertical axis indicates values of joint information.

The example illustrated in FIG. 9E illustrates a state in which, while the timing of the 132-th information G132 remains fixed, the timing of the 131a-th information G131a is shifted to make it adjusted to the 131b-th information G131b, whereby the 132-th information G132 and the 131b-th information G131b are most synchronized.

Here, in the present example, the evaluating unit 113 synchronizes two pieces of information about the joint of the right knee such that the correlation coefficient during a change on a time series is the highest.

In the example illustrated in FIG. 9E, a deviation between two pieces of information is relatively large in a second region R2 during a predetermined period.

As a specific example, when a motion of golf swing is seen in each of t the b1-th moving image Ab1 and the b2-th moving image Ab2 when the same target person differs, and the information about the joint of the right knee is information about the angle or the position or the like of the knee joint, a difference in the motion between the two swings is greater in the right knee joint than in the right shoulder joint. The evaluating unit 113 may determine that the motion of the right knee is more likely to be misaligned in a plurality of times of swings by the same target person, for example.

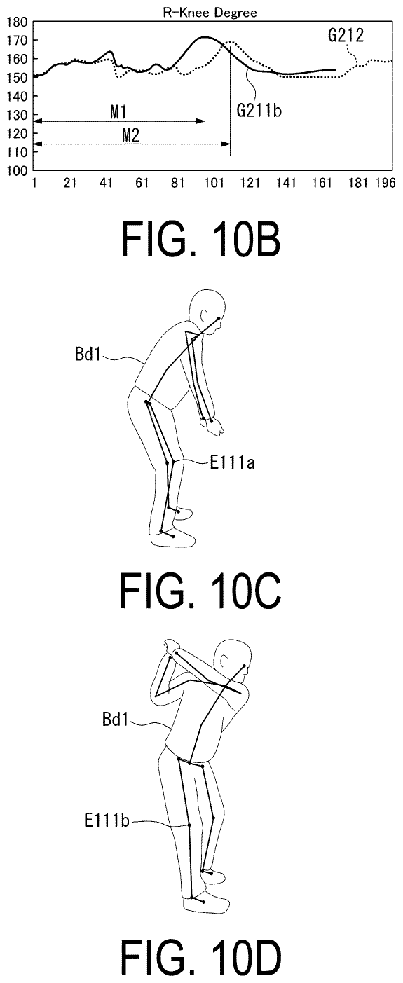

With reference to FIGS. 10A to 10D, description will be made of an example of a process of synchronizing frames of two moving images on the basis of information about a joint to perform evaluation for each joint.

FIG. 10A is a diagram illustrating one example of two pieces of information about the joint of the right knee according to the embodiment. In the present example, these two pieces of information relate to information about a predetermined angle of the joint of the right knee.

In the graph illustrated in FIG. 10A, the horizontal axis indicates the time, and the vertical axis indicates values of joint information.

In the example illustrated in FIG. 10A, these two pieces of information are 211a-th information G211a and 212-th information G212.

Each of the 211a-th information G211a and the 212-th information G212 is information about the joint of the right knee obtained from different images.

The example illustrated in FIG. 10A illustrates these two pieces of information in a state in which timings of these pieces of information are not adjusted in terms of the time on the horizontal axis. In other words, in the example illustrated in FIG. 10A, these two pieces of information are not synchronized with each other.

FIG. 10B is a diagram illustrating one example of a result obtained by shifting relative timing of two pieces of information about the joint of the right knee according to the embodiment.

In the graph illustrated in FIG. 10B, the horizontal axis indicates the time, and the vertical axis indicates values of joint information.

The example illustrated in FIG. 10B illustrates a state in which, while the timing of the 212-th information G212 remains fixed, the timing of the 211a-th information G211a is shifted to make it adjusted to the 211b-th information G211b, whereby the 212-th information G212 and the 211b-th information G211b are most synchronized.

Here, in the present example, the evaluating unit 113 synchronizes two pieces of information about the joint of the right knee such that the correlation coefficient during a change on a time series is the highest.

In connection with the 211b-th information G211b, the example illustrated in FIG. 10B illustrates a first time period M1 from the start of a motion by the target person to a time when the value is at the peak.

In connection with the 212-th information G212, the example illustrated in FIG. 10B illustrates a second time period M2 from the start of a motion by the target person to a time when the value is at the peak.

In the present example, these target persons are the same human. As another example, these target person may be different humans.

In the example illustrated in FIG. 10B, the length of the time period differs between the first time period M1 and the second time period M2.

As a specific example, when application is made to a motion of a target person who performs a golf swing, the timing of address corresponds to a time when the motion starts, and the timing of top position corresponds to a time when a value of joint information is at the peak, the first time period M1 and the second time period M2 differ from each other, and hence, the evaluating unit 113 may determine that timings of swing motions are not constant for the same target person.

Note that, in the golf swing, the posture of address is a posture at which a target person takes a ready position at the time of hitting a ball with a golf club.

In addition, the posture of top position is a posture at the instance when the target person switches from back swing to down swing.

FIG. 10C is a diagram illustrating one example of an address posture of the target person according to the embodiment.

FIG. 10D is a diagram illustrating one example of a top position posture of the target person according to the embodiment.

FIGS. 10C and 10D each illustrate a mode of a motion in which a d1-th target person Bd1 performs a golf swing.

As for the information about the joint of the right knee of the d1-th target person Bd1, FIG. 10C illustrates 11a-th joint information E111a, and FIG. 10D illustrates 111b-th joint information E111b.

Here, in the example illustrated in FIGS. 10C and 10D, the body of the d1-th target person Bd1 is illustrated, whereas tools used by the d1-th target person Bd1 are not illustrated. The tools are, for example, golf clubs.

In addition, the example illustrated in FIGS. 10C and 10D illustrates the body of the d1-th target person Bd1 as well as the bones and joints. However, it may be possible to employ any way of illustrating the d1-th target person Bd1 in the drawings.

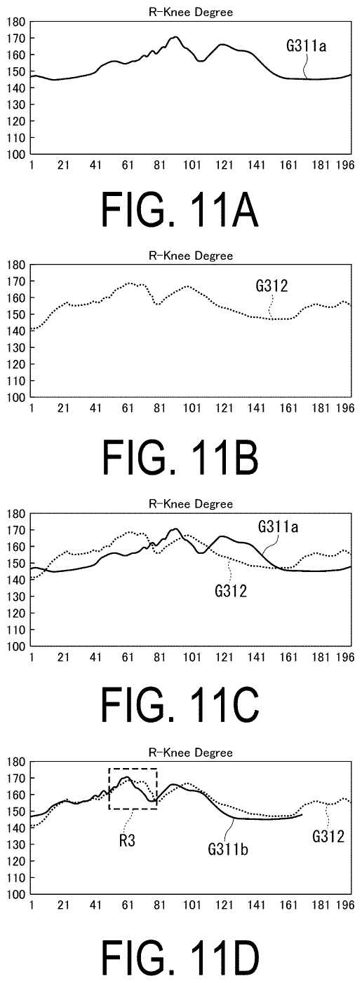

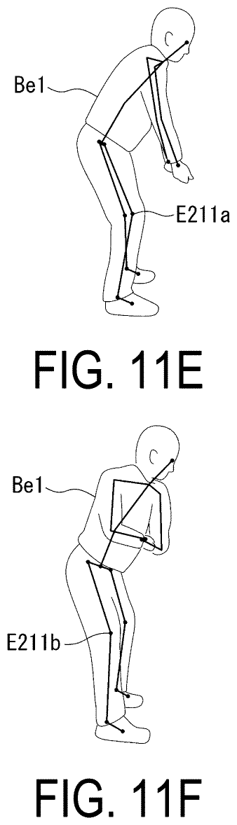

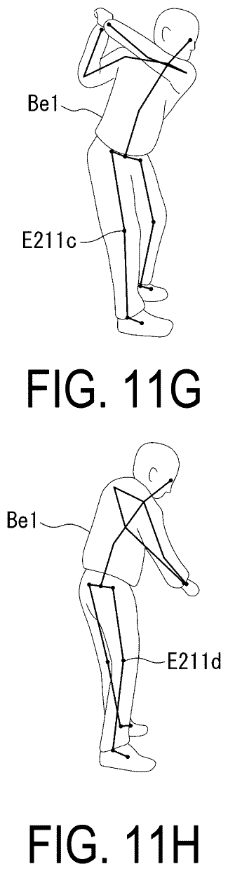

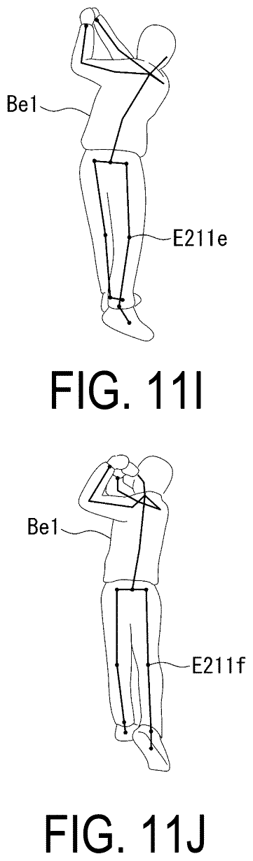

With reference to FIGS. 11A to 11J, description will be made of an example of a process of synchronizing frames of two moving images on the basis of the present and past information about joints, and performing evaluation for each joint.

The present example illustrates a case in which information regarding a predetermined angle of a joint of the right knee of a target person is used as the joint information.

FIG. 11A is a diagram illustrating one example of information about the joint of the right knee according to the embodiment.

In the graph illustrated in FIG. 11A, the horizontal axis indicates the time, and the vertical axis indicates values of joint information.

FIG. 11A illustrates 311a-th information G311a regarding the joint of the right knee of a target person.

In the present example, the 311a-th information G311a is information based on a motion of a target person in a predetermined period. This predetermined period may be “present”, for example.

FIG. 11B is a diagram illustrating another example of information about the joint of the right knee according to the embodiment.

In the graph illustrated in FIG. 11B, the horizontal axis indicates the time, and the vertical axis indicates values of joint information.

FIG. 11B illustrates 312-th information G312 regarding the joint of the right knee of the same target person as that in FIG. 11A.

In the present example, the 312-th information G312 is information based on a motion of the target person in a different period from that of FIG. 11A. This period may be a past period such as a period one month or two months or the like prior to the predetermined period in the example illustrated in FIG. 11A, for example.

FIG. 11C is a diagram illustrating an example of two pieces of information about the joint of the right knee according to the embodiment.

In the graph illustrated in FIG. 11C, the horizontal axis indicates the time, and the vertical axis indicates values of joint information.

In the example illustrated in FIG. 11C, these two pieces of information are the 311a-th information G311a and the 312-th information G312.

The example illustrated in FIG. 11C illustrates these two pieces of information in a state in which timings of these pieces of information are not adjusted in terms of the time on the horizontal axis. In other words, in the example illustrated in FIG. 11C, these two pieces of information are not synchronized with each other.

FIG. 11D is a diagram illustrating one example of a result obtained by shifting relative timing of two pieces of information about the joint of the right knee according to the embodiment.

In the graph illustrated in FIG. 11D, the horizontal axis indicates the time, and the vertical axis indicates values of joint information.

The example illustrated in FIG. 11D illustrates a state in which, while the timing of the 312-th information G312 remains fixed, the timing of the 311a-th information G311a is shifted to make it adjusted to the 311b-th information G311b, whereby the 312-th information G312 and the 311b-th information G311b are most synchronized.

Here, in the present example, the evaluating unit 113 synchronizes two pieces of information about the joint of the right knee such that the correlation coefficient during a change on a time series is the highest.

In connection with motions of a target person in two different periods, the evaluating unit 113 can determine the motion timing that changes between these two different periods, on the basis of the information as indicated in FIG. 11D.

In the example illustrated in FIG. 11D, the evaluating unit 113 may perform evaluation such that the amount of change between the 311b-th information G311b and the 312-th information G312 is large in a third region R3 during a series of motions.

Here, with reference to FIGS. 11E to 11J, description will be made of an example of a case in which application is made to a motion of a golf swing performed by a target person.

FIG. 11E is a diagram illustrating one example of a first form of the target person according to the embodiment.

FIG. 11F is a diagram illustrating one example of a second form of the target person according to the embodiment.

FIG. 11G is a diagram illustrating one example of a third form of the target person according to the embodiment.

FIG. 11H is a diagram illustrating one example of a fourth form of the target person according to the embodiment.

FIG. 11I is a diagram illustrating one example of a fifth form of the target person according to the embodiment.

FIG. 11J is a diagram illustrating one example of a sixth form of the target person according to the embodiment.

FIGS. 11E to 11J each illustrate a mode of a motion that an e1-th target person Be1 performs a golf swing.

In the example illustrated in FIGS. 11E to 11J, a motion of the e1-th target person Be1 is performed in the order from the first form to the sixth form. For example, the first form is a form of an address during a golf swing, and the third form is a form of a top position.

As for information about the joint of the right knee of the e1-th target person Be1, FIG. 11E illustrates 211a-th joint information E211a, FIG. 11F illustrates 211b-th joint information E211b, FIG. 11G illustrates 211c-th joint information E211c, FIG. 11H illustrates 211d-th joint information E211d, FIG. 11I illustrates 211e-th joint information E211e, and FIG. 11J illustrates 211f-th joint information E211f.

Here, in the example illustrated in FIGS. 11E to 11J, the body of the e1-th target person Be1 is illustrated, whereas tools used by the e1-th target person Be1 are not illustrated. The tools are, for example, golf clubs.

In addition, the example illustrated in FIGS. 11E to 11J illustrates the body of the e1-th target person Be1 as well as the bones and joints. However, it may be possible to employ any manner to illustrate the e1-th target person Be1 in the drawings.

In the present example, the motion timing in the third region R3 illustrated in FIG. 11D corresponds to the third form illustrated in FIG. 11G.

On the basis of such information, the evaluating unit 113 may determine that the movement of the right knee in the third form changes between two periods, for example.

As described above, with the information processing device 1 according to the present embodiment, it is possible to accurately synchronize the first moving image and the second moving image in terms of a motion of the target person, which makes it possible to appropriately evaluate the motion of the target person.

With the information processing device 1 according to the present embodiment, a plurality of frames of an evaluation-target moving image relative to a plurality of frames of a comparative moving image are determined such that a similarity of the motion in the evaluation-target moving image relative to the motion in the comparative moving image is the highest, for example. Thus, with the information processing device 1 according to the present embodiment, it is possible to appropriately evaluate the motion in the evaluation-target moving image relative to the motion in the comparative moving image in a state in which the similarity is high.

In this manner, the information processing device 1 according to the present embodiment matches deviations between plural frames of two moving images such that a similarity between the plural frames is high, and synchronizes these two moving images.

Thus, with the information processing device 1 according to the present embodiment, by taking synchronization on the basis of the motion across the plurality of frames, it is possible to improve the accuracy of synchronization, and it is possible to appropriately perform evaluation after synchronization.

Here, as for the process of taking synchronization of two moving images, it may be possible to employ a process of determining a deviation between frames in order to take synchronization, or a process of storing a result of such determination in the storage unit 24, for example.

With the image processing according to the present embodiment, a target to be processed includes a moving image in which specific motions of the same type performed by different persons are captured, or an image in which specific motions of the same type performed by the same person at different starting timings are captured, for example.

Here, the specific motions of the same type performed by different persons are imaged at the same time or different times, for example.

In addition, the specific motions of the same type performed by the same person at different starting timings are captured at different times. Such specific motions may be motions performed in a repeated manner, for example.

The image processing according to the present embodiment may identify information about a plurality of different portions such as positions or angles or the like of a plurality of joints that a human has, on the basis of a moving image in which a specific motion is featured. Note that a known image recognition process may be used for the process of identifying the predetermined portion from the moving image, for example.

Here, the moving image includes time-series change data regarding a portion relating to at least one specific motion, for example.

With the image processing according to the present embodiment, as for time-series change data at two different timings obtained from two moving images, by calculating a similarity obtained by shifting frames between these two pieces of time-series change data, it is possible to synchronize these two pieces of time-series change data, for example.

In addition, with the image processing according to the present embodiment, it is possible to evaluate a similarity or dissimilarity or the like between two pieces of time-series change data in a state in which such synchronization is taken.

Such synchronization and evaluation may be performed for each of a plurality of portions of a human such as each of joints of a human, for example. As a specific example, by comparing two pieces of time-series change data for each of a plurality of portions, it is possible to determine a portion where motions largely differ from each other. Such comparison may be performed in terms of any given information. For example, comparison may be performed in terms of a difference between positions of specific portions, a difference between predetermined angles of specific portions, a difference between timings of a specific form, or the like, for example. In the present embodiment, the evaluating unit 113 performs such comparison.

It is possible to apply the image processing according to the present embodiment to a sports technology, for example.

Typically, when a difference from a proper form is pointed out to a target person and the target person tries to correct the pointed-out issue in order to improve performance in sports, the target person often cannot sufficiently grasp the tendency and habit of his or her own motion. In other words, typically, it is often difficult for the target person to grasp which portion in the body is more likely to misalign or the like during motions repeated a plurality of times.

In contrast, with a result of evaluation obtained from the image processing according to the present embodiment, the target person can grasp a portion that is more likely to misalign or a portion that the target person needs to be more conscious of concerning his or her own tendency of movement, which is expected to help the target person correct the movement.

The image processing according to the present embodiment analyzes a captured moving image to acquire information about a position or an angle or the like of each portion of the body of the target person, and determines the degree of variation or the like for each portion of the body on the basis of a plurality of times of motions of the same type.

Furthermore, with the image processing according to the present embodiment, it is possible to perform comparison and evaluation between the current motion and the past motion such as a motion one week ago or one month ago in terms of the same target person, and it is possible to know how the movement of the target person himself or herself has changed.

In addition, with the image processing according to the present embodiment, it is possible to perform comparison and evaluation between the movement of a target person who wishes to improve performance in sports and the movement of a model professional person or the like, which enables the target person to grasp points for improving his or her own movement.

As another example, when evaluating a golf swing motion of a target person captured in a moving image, the information processing device 1 determines a plurality of frames of an evaluation-target moving image that correspond to a plurality of frames of a comparative moving image such that a similarity of a swing motion of the evaluation-target moving image relative to a swing motion of the comparative moving image is the highest. Then, the information processing device 1 is able to appropriately evaluate the swing motion of the evaluation-target moving image relative to the swing motion of the comparative moving image in a state in which the similarity is high.

With the information processing device 1, it is possible to analyze a moving image in which a plurality of times of motions of the same type is captured on the same target person to determine a portion that is more likely to misalign or a portion that peculiarly moves or the like in a body within a series of motions such as a golf swing. Then, the information processing device 1 provides information such as a portion of the body that the target person needs to be more conscious of, thereby enabling the target person to correct the posture, which makes it possible to improve the performance in sports. At this time, in order to evaluate a difference of the movement of the target person in a plurality of different moving images, the information processing device 1 searches for a timing at which the similarity of a movement of a certain joint is the highest in a time-series manner, and determines frames such that two moving images are associated at this timing, thereby synchronizing two moving images.

In this manner, on the basis of a result of analysis of a motion for the purpose of correcting the posture and improving the performance in sports, the information processing device 1 is able to evaluate misalignment when the same person repeats the same type of motions or is able to evaluate an personal form through comparison with a correct form.

Here, the present embodiment describes a case in which a target person performs a golf swing motion as one example of sports. However, as for the sports, it may be possible to apply the present embodiment to any given sports, and for example, it may be possible to apply the present embodiment to various types of sports such as baseball, football, or tennis. As a specific example, the information processing device 1 may evaluate a batting form in baseball, a pitching form, a kicking form in football, a swing form in tennis, or the like.

Furthermore, the information processing device 1 or the like according to the present embodiment may be applied to a case in which the target person performs a motion other than sports, for example.

Note that the present embodiment describes a case in which information or the like about a joint of a target person seen in a moving image is acquired on the basis of information regarding the moving image. However, as another example, it may be possible to use information in which a plurality of separate still image frames are grouped. When information in which a plurality of still image frames are grouped is used in this manner, it is possible to perform a process substantially similar to a case in which information about a moving image is used, for example. Such information in which a plurality of still image frames are grouped may be regarded as information about a moving image, and may be used.

Furthermore, the present embodiment describes a case in which information or the like about a joint of a target person seen in a moving image is acquired on the basis of information about the moving image. However, as another example, it may be possible to employ a configuration in which information or the like about a joint of a target person is acquired on the basis of information detected by a sensor.

In other words, it may be possible to identify a movement of a joint or the like of a target person on the basis of a result of detection from a sensor attached to the body of the target person, or it may be possible to identify a movement of a joint or the like of the target person on the basis of a movement of a tool that is a result of detection from a sensor attached to the tool used by the target person. The misalignment of the movement or the deviation of timing in the movement or the like may be determined on the basis of such information about a result of detection from the sensor.

For example, it may be possible to employ a configuration in which one of or both of two modes are performed. The two modes includes: a mode in which information about a joint or the like of a target person is acquired on the basis of information detected by a sensor attached to the body of the target person; and a mode in which information about a joint or the like of a target person is acquired on the basis of information detected by a sensor attached to a predetermined location outside of the target person.

Here, there is not particular limitation as to the predetermined location outside of the target person. For example, it may be possible to set a predetermined location of a tool used by the target person. This tool may be a tool in sports performed by the target person. For example, the tool may be a golf club, a baseball bat or baseball glove, a soccer ball, a tennis racket, or the like.

In addition, the number of sensors used may be any number equal to or more than one.

Furthermore, any sensor may be used for the sensor. For example, it may be possible to use one or more of an acceleration sensor, a position sensor, an angular velocity sensor, and the like.

In this manner, a sensor configured to detect information about a target person may be used instead of a camera that captures a moving image of the target person.

In addition, for example, it may be possible to use a sensor configured to detect information about a target person in conjunction with a camera configured to capture a moving image of the target person. In this case, it may be possible to acquire various types of information regarding the target person on the basis of one of or both of information regarding a moving image captured by the camera and information detected by the sensor.

Note that, here, the sensor represents a unit other than a camera, and various types of sensors may be used instead of the camera or in conjunction with the camera.

A program for realizing the function of any constituent unit in any device described above may be recorded on a computer-readable recording medium, and the program may be read and executed by a computer system. The “computer system” as used herein is assumed to include hardware such as an operating system or peripheral devices. The “computer-readable recording medium” is a storage device such as a portable medium such as a flexible disk, a magneto-optical disk, a read only memory (ROM), a compact disc (CD)-ROM, and a hard disk built into a computer system. The “computer-readable recording medium” is assumed to include a medium that holds a program for a certain period of time, such as a volatile memory provided inside of a computer system serving as a server or a client when the program is transmitted via a network such as the Internet or a communication line such as a telephone line. The volatile memory may be a RAM. The recording medium may be a non-transitory recording medium.

The program described above may be transmitted from a computer system storing this program in a storage device or the like via a transmission medium or using transmission waves in a transmission medium to another computer system. The “transmission medium” from which the program is transmitted refers to a medium having a function of transmitting information, such as a network such as the Internet or a communication line such as a telephone line.

The program described above may be a program for realizing a portion of the above-described functions. The program described above may be a so-called difference file, which can realize the above-described functions in combination with a program already recorded in the computer system. The difference file may be called a difference program.

The function of any constituent unit in any device described above may be realized by a processor. Each of the processes in the embodiment may be realized by a processor that operates on the basis of information such as a program and a computer-readable recording medium that stores information such as a program. In the processor, the function of each unit may be realized by individual hardware, or the function of each unit may be realized by integrated hardware. The processor may include hardware, and the hardware may include at least one of a circuit for processing digital signals and a circuit for processing analog signals. The processor may be configured using one of or both of one or more circuit devices or one or more circuit elements mounted on a circuit board. For the circuit device, an integrated circuit (IC) or the like may be used, and for the circuit element, a resistor, a capacitor, or the like may be used.

The processor may be a CPU. However, the processor is not limited to the CPU, and it may be possible to use various processors such as a graphics processing unit (GPU) or a digital signal processor (DSP). The processor may be a hardware circuit using an application-specific integrated circuit (ASIC). The processor may be configured by a plurality of CPUs or may be configured by a hardware circuit including a plurality of ASICs. The processor may be configured by a combination of a plurality of CPUs and a hardware circuit including a plurality of ASICs. The processor may include one or more of an amplifier circuit, a filter circuit, and the like for processing analog signals.

These are detailed descriptions of the embodiment with reference to the drawings. However, the specific configurations are not limited to those of this embodiment, and include designs and the like without departing from the gist of the present disclosure.

### APPENDIX

Below, description will be made of <First Configuration Example> to <Fifteenth Configuration Example>.

Note that a lower configuration example may or may not be applied to a higher configuration example.

In addition, a lower configuration example applicable to any one of two or more higher configuration examples may be applied to any configuration example of the two or more higher configuration examples. In other words, two or more application examples may be generated, and configuration examples lower than the lower configuration examples described above may be applied to any application example of the two or more application examples.

### First Configuration Example

An information processing device including:
an acquiring unit configured to acquire a first moving image and a second moving image;
an extracting unit configured to extract a first motion from the first moving image and extract a second motion from the second moving image; and
an evaluating unit configured to determine a plurality of frames of the second moving image, the frames being frames in which a similarity of the second motion of the second moving image relative to the first motion of the first moving image is equal to or more than a predetermined value.

### Second Configuration Example

The information processing device according to <First Configuration Example>, in which the number of frames differs between the first moving image and the second moving image.

### Third Configuration Example

The information processing device according to <First Configuration Example> or <Second Configuration Example>, in which
the first moving image is a moving image in which the first motion of a first target person is imaged, and
the second moving image is a moving image in which the second motion of a second target person is imaged.

### Fourth Configuration Example

The information processing device according to <First Configuration Example> or <Second Configuration Example>, in which
the first moving image is a moving image in which the first motion of a first target person is imaged,
the second moving image is a moving image in which the second motion of the first target person is imaged, and
the second moving image is a moving image captured before the first moving image or is a moving image captured after the first moving image.

### Fifth Configuration Example

The information processing device according to any one of <First Configuration Example> to <Fourth Configuration Example>, in which the similarity is a coefficient indicating a correlation between data regarding the first motion and data regarding the second motion.

### Sixth Configuration Example

The information processing device according to any one of <First Configuration Example> to <Fifth Configuration Example>, in which the evaluating unit determines a plurality of frames of the second moving image in which the similarity of the second motion of the second moving image relative to the first motion of the first moving image is highest.

### Seventh Configuration Example

The information processing device according to any one of <First Configuration Example> to <Fifth Configuration Example>, in which the evaluating unit determines, for each of a plurality of joints, a plurality of frames of the second moving image in which the similarity of the second motion of the second moving image relative to the first motion of the first moving image is equal to or more than the predetermined value.

### Eighth Configuration Example

The information processing device according to <Seventh Configuration Example>, in which
the evaluating unit sets, as a representative joint, the joint in which the similarity is highest from among a plurality of the joint, and sets a plurality of frames of the second moving image in which the similarity of the representative joint is highest, as a plurality of frames used to evaluate another joint.

### Ninth Configuration Example

The information processing device according to <Seventh Configuration Example>, in which
the evaluating unit sets, as a representative joint, the joint selected by a target person from among a plurality of the joints, and sets a plurality of frames of the second moving image in which the similarity of the representative joint is highest, as a frame used to evaluate another joint.

### Tenth Configuration Example

The information processing device according to any one of <First Configuration Example> to <Ninth Configuration Example>, in which
for a plurality of frames of the second moving image in which the similarity of the second motion of the second moving image relative to the first motion of the first moving image is equal to or more than the predetermined value, the evaluating unit evaluates the second motion relative to the first motion.

### Eleventh Configuration Example

The information processing device according to any one of <First Configuration Example> to <Tenth Configuration Example>, in which
the evaluating unit uses data indicating a movement of each of joints in the second motion relative to data indicating a movement of each of the joints in the first motion to evaluate the second motion relative to the first motion.

### Twelfth Configuration Example

The information processing device according to any one of <First Configuration Example> to <Eleventh Configuration Example>, in which
when the similarity of one joint is lower than an average value of the similarity of a plurality of joints including the similarity of other joints, or deviates from a standard deviation of the similarity of a plurality of joints including the similarity of the other joint, the evaluating unit determines that the joints are misaligned.

### Thirteenth Configuration Example

The information processing device according to any one of <First Configuration Example> to <Twelfth Configuration Example>, in which
the evaluating unit evaluates data regarding a temporal movement of a joint, and
the information processing device includes an output unit configured to output different information between when an error of data regarding a temporal movement of the joint is large and when an error of data regarding a temporal movement of the joint is small.

It is possible to provide a processing method performed by the information processing device as described above.

### Fourteenth Configuration Example

An information processing method including:
acquiring, by an acquiring unit, a first moving image and a second moving image;
extracting, by an extracting unit, a first motion from the first moving image, and extracting, by the extracting unit, a second motion from the second moving image; and
determining, by an evaluating unit, a plurality of frames of the second moving image, the frames being frames in which a similarity of the second motion of the second moving image relative to the first motion of the first moving image is equal to or more than a predetermined value.

It is also possible to provide a program recording medium that records a program performed by a processor in the information processing device as described above.

### Fifteenth Configuration Example

A non-transitory computer-readable recording medium that records a program, the program causing a computer to perform:
acquiring a first moving image and a second moving image;
extracting a first motion from the first moving image;
extracting a second motion from the second moving image; and
determining a plurality of frames of the second moving image, the frames being frames in which a similarity of the second motion of the second moving image relative to the first motion of the first moving image is equal to or more than a predetermined value.

What is claimed is:

1. An information processing device including:
an acquiring unit configured to acquire a first moving image and a second moving image;
an extracting unit configured to extract a first motion from the first moving image and extract a second motion from the second moving image; and
an evaluating unit configured to determine a plurality of frames of the second moving image, the frames being frames in which a similarity of the second motion of the second moving image relative to the first motion of the first moving image is equal to or more than a predetermined value.

2. The information processing device according to claim 1, wherein the number of frames differs between the first moving image and the second moving image.

3. The information processing device according to claim 1, wherein
the first moving image is a moving image in which the first motion of a first target person is imaged, and
the second moving image is a moving image in which the second motion of a second target person is imaged.

4. The information processing device according to claim 1, wherein
the first moving image is a moving image in which the first motion of a first target person is imaged,
the second moving image is a moving image in which the second motion of the first target person is imaged, and
the second moving image is a moving image captured before the first moving image or is a moving image captured after the first moving image.

5. The information processing device according to claim 1, wherein
the similarity is a coefficient indicating a correlation between data regarding the first motion and data regarding the second motion.

6. The information processing device according to claim 5, wherein
the evaluating unit determines a plurality of frames of the second moving image in which the similarity of the second motion of the second moving image relative to the first motion of the first moving image is highest.

7. The information processing device according to claim 5, wherein
the evaluating unit determines, for each of a plurality of joints, a plurality of frames of the second moving image in which the similarity of the second motion of the second moving image relative to the first motion of the first moving image is equal to or more than the predetermined value.

8. The information processing device according to claim 7, wherein
the evaluating unit sets, as a representative joint, a joint in which the similarity is highest from among the plurality of joints, and sets a plurality of frames of the second moving image in which the similarity of the representative joint is highest, as a plurality of frames used to evaluate another joint.

9. The information processing device according to claim 7, wherein
the evaluating unit sets, as a representative joint, a joint selected by a target person from among the plurality of joints, and sets a plurality of frames of the second moving image in which the similarity of the representative joint is highest, as a frame used to evaluate another joint.

10. The information processing device according to claim 1, wherein
for a plurality of frames of the second moving image in which the similarity of the second motion of the second moving image relative to the first motion of the first moving image is equal to or more than the predetermined value, the evaluating unit evaluates the second motion relative to the first motion.

11. The information processing device according to claim 10, wherein
the evaluating unit uses data indicating a movement of each of joints in the second motion relative to data indicating a movement of each of the joints in the first motion to evaluate the second motion relative to the first motion.

12. The information processing device according to claim 10, wherein
when the similarity of one joint is lower than an average value of the similarity of a plurality of joints including the similarity of other joints, or deviates from a standard deviation of the similarity of a plurality of joints including the similarity of the other joint, the evaluating unit determines that the joints are misaligned.

13. The information processing device according to claim 10, wherein
the evaluating unit evaluates data regarding a temporal movement of a joint, and
the information processing device includes an output unit configured to output different information between when an error of data regarding a temporal movement of the joint is large and when an error of data regarding a temporal movement of the joint is small.

14. An information processing method including:
acquiring, by an acquiring unit, a first moving image and a second moving image;
extracting, by an extracting unit, a first motion from the first moving image, and extracting, by the extracting unit, a second motion from the second moving image; and
determining, by an evaluating unit, a plurality of frames of the second moving image, the frames being frames in which a similarity of the second motion of the second moving image relative to the first motion of the first moving image is equal to or more than a predetermined value.

15. A non-transitory computer-readable recording medium that records a program, the program causing a computer to perform:
acquiring a first moving image and a second moving image;
extracting a first motion from the first moving image;
extracting a second motion from the second moving image; and
determining a plurality of frames of the second moving image, the frames being frames in which a similarity of the second motion of the second moving image relative to the first motion of the first moving image is equal to or more than a predetermined value.
